(19) United States
(12) Patent Application Publication
(10) Pub. No.: US 2009/0285576 A1
(43) Pub. Date: Nov. 19, 2009

(54) Method and apparatus for feedback/configuration of optical network terminal (ONT) anomalies to/from a central location

(75) Inventors: Jeffrey A. Noel, Leesburg, VA (US); Fung-Chang Huang, Herndon, VA (US); Adrian S. Chan, New Market, MD (US); David H. Liu, Herndon, VA (US); Marc R. Bernard, Miramar, FL (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Tellabs Vienna, Inc., Naperville, IL (US)

(21) Appl. No.: 12/152,711

(22) Filed: May 16, 2008

(51) Int. Cl. H04B 10/08

(52) U.S. Cl. 398/17

(57) ABSTRACT

A method and system for collecting and analyzing diagnostic data relating to an Optical Network Terminal (ONT) anomaly or failure is disclosed. Example embodiments of the method and system employ a SIP configuration server to collect and analyze diagnostic data efficiently to determine a cause of the anomaly or failure in both live and post-mortem scenarios. The collected data may be communicated to a central location, where analysis of the data may be conveniently performed by a technical support entity. The method and system are scalable and may be applied to an entire installed base of ONTs across many individual Passive Optical Networks (PONs).

### BACKGROUND OF THE INVENTION

High bandwidth communications traffic is typically distributed over a high bandwidth channel to a network terminal that provides an interface to a Local Area Network (LAN). The network terminal includes an interface to receive data from the high bandwidth channel, as well as one or more interfaces for distributing data to a local network, such as, for example, an Ethernet-based LAN or an in-home network for distribution of broadband data using coaxial cable. In a Passive Optical Network (PON), the network terminal is an Optical Network Terminal (ONT), which uses ONT operating parameters to operate in the PON.

Such parameters for the ONT may be stored both locally at the ONT and elsewhere on the network (e.g., at a central office). Examples of ONT operating parameters include parameters for ATM Adaptation Layer Type 1 (AAL1)/Session Initiation Protocol (SIP) mode, Ground Start/Loop Start mode, and video administrator state. In general, SIP creates, modifies, and terminates sessions, such as Internet telephone calls, multimedia distribution, and multimedia conferences, with one or more participants. Data indicative of operating history of the ONT (e.g., occurrence of alarm conditions or statistics regarding volume of data packets sent and received) may also be stored by the ONT. ONTs are often returned to manufacturers by customers as being problem ONTs, but with subsequent testing of the ONTs revealing no fault in the ONTs themselves.

### SUMMARY OF THE INVENTION

According to one embodiment, a Session Initiation Protocol (SIP) network node is provided that includes a SIP configuration module, which provides a call configuration to a terminal node in a SIP network for use during call operations. The SIP network node also includes a data collection module that is configured to collect data from the terminal node that is unrelated to the call configuration. The data collection module is also configured to report a representation of that data for diagnostics.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a network diagram of an example Passive Optical Network (PON) with an Element Management System (EMS) and a Session Initiation Protocol (SIP) configuration server.

FIG. 2A is a network diagram illustrating communicating configuration information in a PON with a SIP configuration server.

FIG. 2B is a network diagram illustrating a PON with a SIP configuration server having a SIP configuration module and a data collection module.

FIG. 3 is a network diagram illustrating an embodiment of the present invention in which a data collection module of a SIP configuration server collects data from an Optical Network Terminal (ONT).

FIG. 4 is a network diagram illustrating an embodiment of the present invention in which a data collection module of a SIP configuration server collects data from an ONT and sends data to a central location for diagnostics.

FIG. 5 is a network diagram illustrating an embodiment of the present invention in which data from multiple ONTs is collected at multiple SIP configuration servers and sent to a central location for diagnostics.

FIG. 6A-6C are network diagrams illustrating collecting data from an ONT and further configuring the ONT based on collected data.

FIG. 7 is a flow diagram illustrating collecting data from an ONT at a SIP configuration server and reporting data for diagnostics.

FIG. 8 is a flow diagram illustrating collecting data from an ONT at a SIP configuration server, requesting additional data from the ONT, and reporting data for diagnostics.

FIG. 9 is a flow diagram illustrating detecting an ONT anomaly or failure, writing data relating to the anomaly or failure to memory, and sending data to a SIP configuration server.

### DETAILED DESCRIPTION OF THE INVENTION

A description of example embodiments of the invention follows.

Currently, an efficient method for collecting and analyzing diagnostic data relating to an Optical Terminal Network (ONT) anomaly or failure does not exist. Methods and systems according to example embodiments of the present invention are provided that allow for such efficient collecting and analyzing of diagnostic data to determine a cause of the anomaly or failure in both live and post-mortem scenarios. Example embodiments may be applied to an entire installed base of ONTs across many individual Passive Optical Networks (PONs), and the data from each ONT may be transmitted to a central location where analysis of the data may be conveniently performed by a technical support entity.

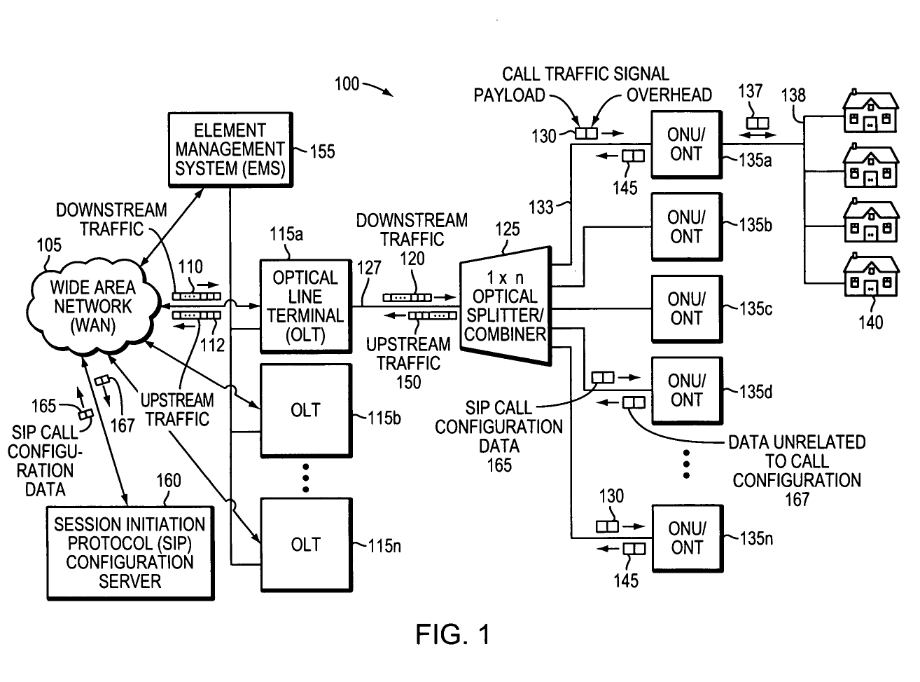

FIG. 1 is a network diagram of a Passive Optical Network (PON) 100 according to an example embodiment of the present invention. The network 100 includes at least one optical line terminal (OLT) 115a-115n, an Element Management System (EMS) 155, a Session Initiation Protocol (SIP) configuration server 160, an Optical Splitter/Combiner (OSC) 125, and at least one Optical Network Unit (ONU), or Optical Network Terminal (ONT), 135a-135n (hereinafter both referred to as an ONT). Data communications 110, 112 may be transmitted between the OLTs 115a-115n and a Wide Area Network (WAN) 105.

Communication of data transmitted between a given OLT 115a and its associated ONTs 135a-135n may be performed using standard communication protocols known in the art. For example, point-to-multipoint (e.g., broadcast with identifiers of intended recipients) for transmitting downstream data 120 from the OLT 115a to the ONTs 135a-135n and point-to-point for transmitting upstream data 150 from an individual ONT 135a-135n back to the OLT 115a (e.g., Time Division Multiple Access (TDMA)).

The PON 100 may be deployed for fiber-to-the-premise (FTTP), fiber-to-the-curb (FTTC), fiber-to-the-node (FTTN), and other fiber-to-the-x (FTTX) applications. The optical fiber 127, 133 in the PON 100 may operate at bandwidths such as 155 Mb/sec, 622 Mb/sec, 1.25 Gb/sec, and 2.5 Gb/sec, or any other desired bandwidth implementation. The PON 100 may incorporate Asynchronous Transfer Mode (ATM) communications, broadband services such as Ethernet access and video distribution, Ethernet point-to-multipoint topologies, native communications of data and Time Division Multiplex (TDM) formats, and other communications suitable for a PON. Customer premise equipment (e.g., inside homes 140) that can receive and provide communications in the PON 100 may include standard telephones (e.g., Public Switched Telephone Network (PSTN) and cellular), Internet Protocol (IP) telephones, Ethernet units, video devices, computer terminals, digital subscriber line connections, cable modems, wireless access, as well as any other conventional customer premise equipment.

The OLT 115a generates or passes through downstream communications 120 to an OSC 125. After passing through the OSC 125, the downstream communications 130 (such as call traffic signals) are broadcast to the ONTs 135a-135n, where each ONT 135a-135n reads data 130 intended for that particular ONT 135a-135n using, for example, identification information embedded within the communications signal. Data communications 137 may be further transmitted to and from, for example, a user's home 140 in the form of voice, data, video, and/or telemetry over copper, fiber, or other suitable connection 138 as known to those skilled in the art. The ONTs 135a-135n transmit upstream communication signals 145 back to the OSC 125 via fiber connections 133. The OSC 125, in turn, combines the ONTs 135a-135n upstream communications signals 145 and transmits the combined signals 150 back to the OLT 115a using, for example, a TDM protocol. The OLT 115a may further transmit the communication signals 112 to the WAN 105. In embodiments of the present invention, a SIP configuration module of the SIP configuration server 160 transmits SIP call configuration data 165 via the PON to the ONTs, and a data collection module of the SIP configuration server 160 collects data 167 unrelated to the call configurations from the ONTs.

Communications between the OLT 115a and the ONTs 135a-135n occur using a downstream wavelength and an upstream wavelength. The downstream communications from the OLT 115a to the ONTs 135a-135n may be provided at, for example, 622 megabytes per second, which may be shared across all ONTs. The upstream communications from the ONTs 135a-135n to the OLT 115a may be provided, at for example, 155 megabytes per second, which may be shared among all ONTs 135a-135n connected to the OSC 125.

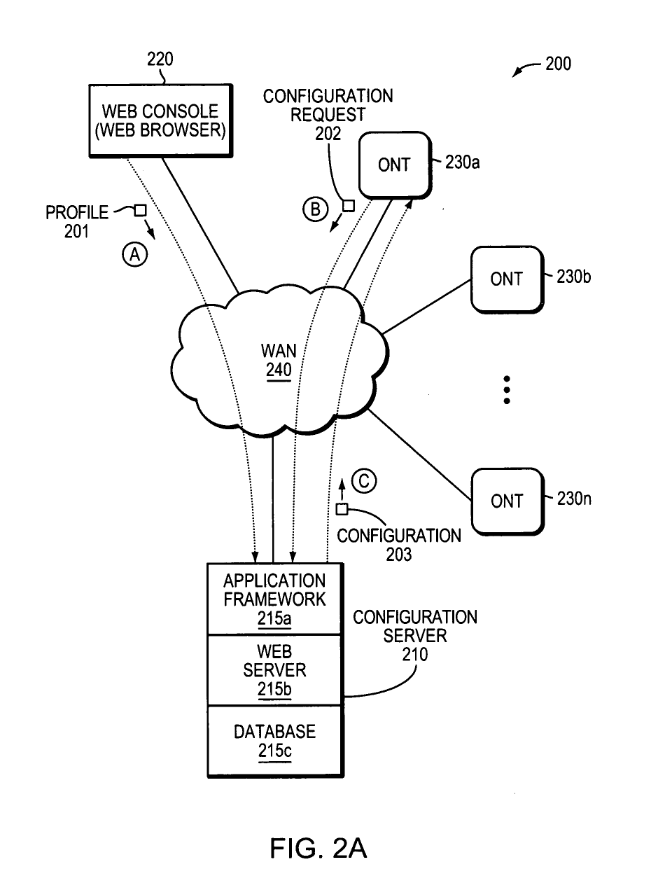

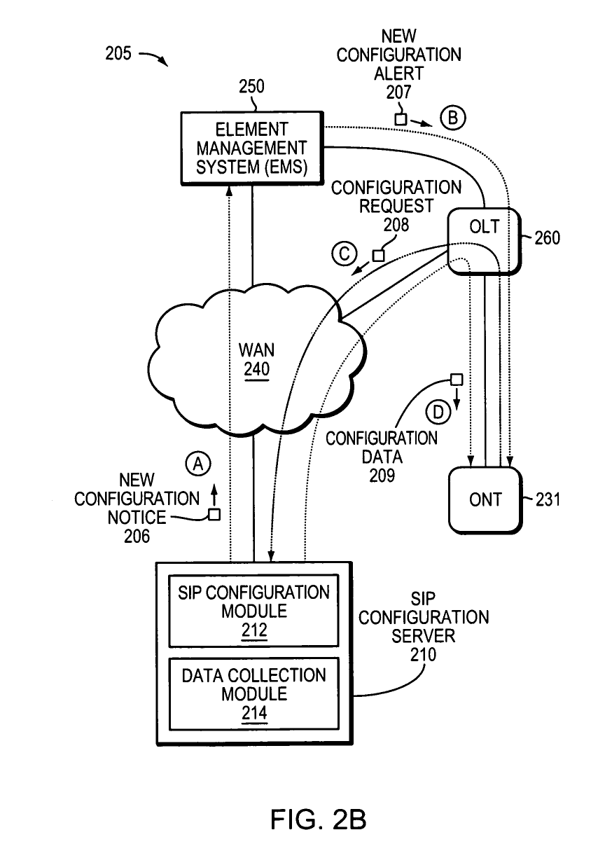

FIG. 2A is a network diagram 200 illustrating communicating configuration information in a Passive Optical Network (PON), such as the PON of FIG. 1, and illustrating a SIP configuration server 210 that enables network operators to configure settings (e.g., SIP parameters in the case of a SIP network) on an ONT 230 in a convenient and secure fashion. The SIP configuration server 210 provides a system that includes a graphical user interface that is used for managing a database of settings (e.g., SIP configuration parameters for use in a SIP network) and that enables the ONTs 230a-230n to request those configuration settings securely over the Internet 240.

The SIP configuration server 210 allows a network operator to change services on a large group of ONTs 230 at one time through the use of profiles 201. Such profiles 201 are created for users in the network, and for each profile, a single profile is saved in a database 215c, and assigned to multiple ONTs 230. The profile is then propagated to all of the ONTs 230 to which it is assigned. When configuring ONTs in a SIP network, the ONTs 230 may be configured without use of the SIP protocol stack.

The example system of FIG. 2A includes a SIP configuration server 210 and a user console (interface) 220. The SIP configuration server 210 runs an operating system (such as Linux) and typically includes three major components: an Application Framework 215a (such as Ruby on Rails), a Web Server 215b (such as Apache), and a Database 215c (such as MySQL). A user of the system can modify ONT configurations (or profiles) 201 through the interface 220, which may be a web browser in this example. According to the example, the profiles 201 are stored in the database 215c of the SIP configuration server 210 and are used by the SIP configuration server 210 to generate a configuration file that is ultimately retrieved by at least one ONT 230.

During ONT operation, an ONT 230 may send a request 202 to the SIP configuration server 210 asking for the configuration associated with the ONT 230. Additionally, the system may include an Element Management System (EMS) that alerts the ONTs 230 when a new configuration is available, and the ONTs 230 may then request their configurations in response to the “new configuration” alert.

FIG. 2B is a network diagram 205 illustrating a Passive Optical Network (PON), such as the PON of FIG. 2A, with such an Element Management System (EMS) 250. According to the system illustrated in FIG. 2B, the EMS 250 notifies an ONT 231 of a new configuration. Typically, an ONT 231 will periodically poll the SIP configuration server 210 for its configuration (e.g., every 24 hours); however, an ONT 231 may be notified of the existence of a new configuration so that the ONT 231 may immediately send a request for its updated configuration.

In this case, when a new configuration is available, the SIP configuration server 210 sends a notice 206 of the new configuration to the EMS 250. Upon receiving the notice 206 from the SIP configuration server 210, the EMS 250 sends an alert 207 regarding the new configuration to an OLT 260, which passes the alert 207 along to at least one associated ONT 231. When the ONT 231 receives the alert 207, it may then send a configuration request 208 to the SIP configuration server 210. Upon receipt of the request 208, a SIP configuration module 212 of the SIP configuration server 210 then sends the ONT's configuration 209 to the ONT 231.

The SIP configuration server 210 may communicate through a separate channel to retrieve additional information for a particular user, such as a specific ONT identifier for the user. This communication enhances the overall ability to provision additional information for users based on information that is already available via the EMS 250. It should be noted that no SIP messaging is necessary, and that the SIP configuration server 210 instead uses the separate communication channel to communicate SIP information. Communications between the SIP configuration server 210 and the EMS 250 may be supported by Transaction Language 1 (TL1), XML, or any other standard or proprietary communication technique. Additionally, communications may involve shared access to a database that may be managed by the EMS 250. Further details regarding the SIP configuration server may be found in U.S. application Ser. No. 11/804,574, filed on May 18, 2007, and entitled “Method and Apparatus for Configuring Optical Network Terminals (ONT) in a Network,” which is incorporated herein by reference in its entirety.

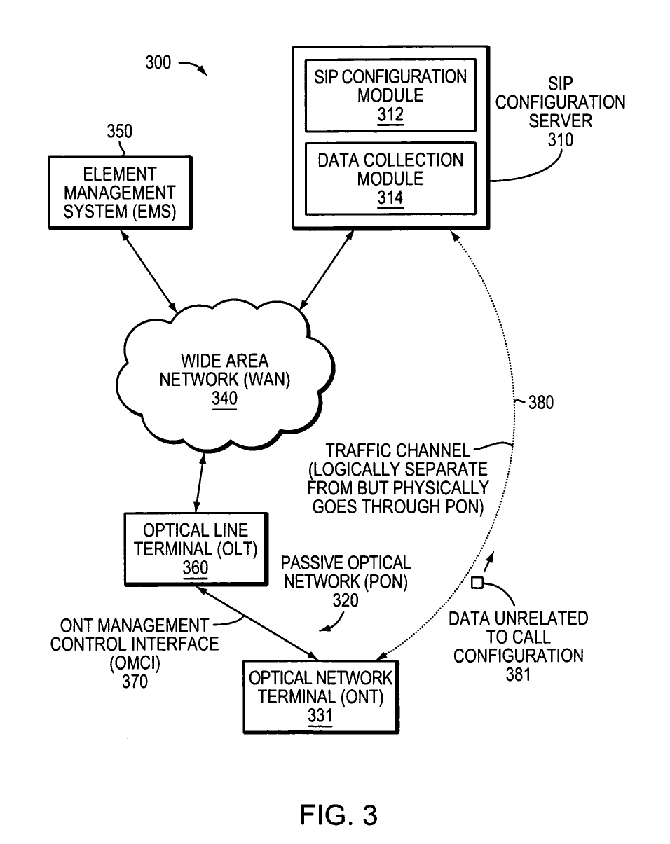

FIG. 3 is a network diagram 300 illustrating an embodiment of the present invention in which a data collection module 314 of a SIP configuration server 310 collects data 381 from an ONT 331. In accordance with embodiments of the present invention, such as the embodiment of FIG. 3, the SIP configuration server 310 described above is utilized to collect and analyze the data 381, and to adjust the type of data that the ONT 331 sends to the data collection module 314 of the SIP configuration server 310.

The embodiment illustrated in FIG. 3 is a Passive Optical Network (PON) that includes an ONT 331 managed by an Element Management System (EMS) 350 via a Wide Area Network (WAN) 340 and an Optical Line Terminal (OLT) 360. In the example embodiment, communications between the OLT 360 and the ONT 331 are accomplished using an ONT Management Control Interface (OMCI). A SIP configuration server 310, as described above, is also included, which communicates with the ONT 331 via a traffic channel 380 that is logically separate from the PON, but which still travels through the PON. An example of such a traffic channel 380 may be a Hyper-Text Transfer Protocol (HTTP) channel, which is a traffic channel that transports messages using the HTTP protocol. There may already be such an HTTP link established between the SIP configuration server 310 and the ONT 331, which may already be used by the SIP configuration server 310 to configure, for example, SIP Voice Over Internet Protocol (VOIP) parameters on the ONT 331.

According to the example embodiment of FIG. 3, a SIP configuration module 312 of the SIP configuration server 310 provides a call configuration to the ONT 331 for use during call operations. Also according to the example embodiment, a data collection module 314 of the SIP configuration server 310 is configured to collect data 381 from the ONT 331 that is unrelated to the ONT's call configuration. In collecting the data 381 from the ONT 331, the data collection module 314 may be configured to collect different data based on, for example, a state of communications between the ONT 331 and its associated management node (e.g., the EMS 350) or whether communications between the ONT 331 and the associated management node have been established, established and then lost, or never established. According to the example embodiment, the data collection module 314 is also configured to report a representation of the data collected from the ONT 331 for diagnostics.

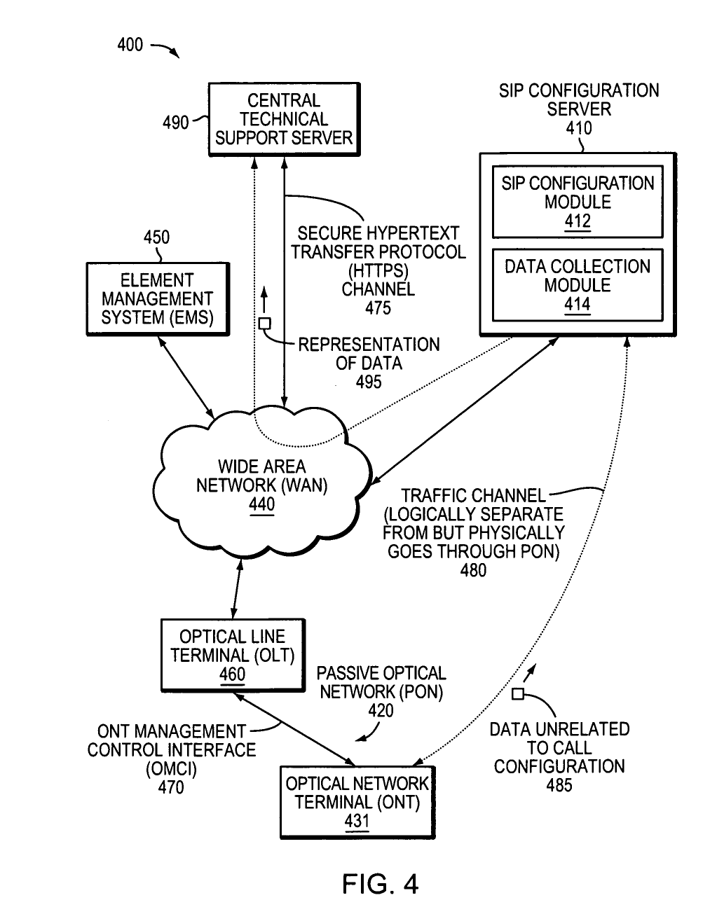

FIG. 4 is a network diagram 400 illustrating an embodiment of the present invention in which a data collection module 414 of a SIP configuration server 410 collects data 485 from an ONT 431 and sends a representation of the data 495 to a central location 490. The example embodiment illustrated in FIG. 4 is similar to the example embodiment of FIG. 3, but it also illustrates a central technical support server 490 to which the data collection module 414 sends the representation 495 of the data 485 collected from the ONT 431. According the to example embodiment, the data collection module 414 is configured to report a representation 495 of the data 485 collected from the ONT 431 to a remote location 490 (e.g., the central technical support server) for analysis. Once the data collection module 414 communicates the representation 495 of the data 485 it collects to such a central repository 490, the data 495 may be analyzed based on a number of parameters. It should be noted that in some embodiments, the representation 495 of the data 485 may be the data 485 itself.

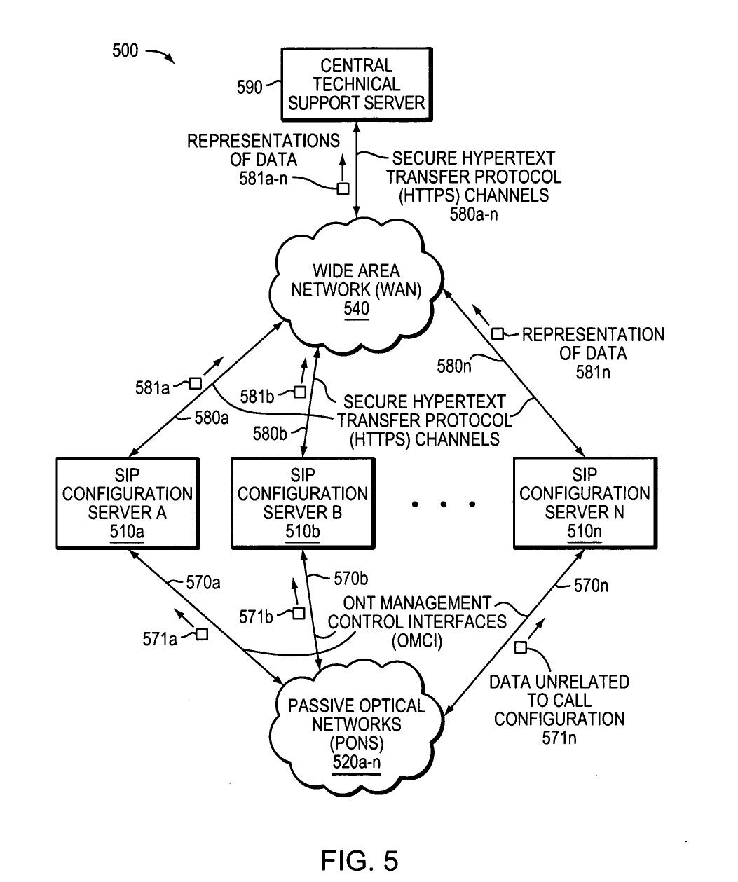

FIG. 5 is a network diagram 500 illustrating an embodiment of the present invention in which data 571a-n from multiple ONTs (not shown) is collected at multiple SIP configuration servers 510a-n and a representation 581a-n of the data 571a-n is sent to a central location 590. The embodiments of the present invention are scalable and may be applied to any number of ONTs. For example, embodiments of the present invention may analyze data 581 relating to an entire installed base of ONTs across multiple PON networks 520a-n, or may analyze data 581 relating to a subset of the ONTs (e.g., the ONTs for a particular service provider, city, neighborhood, OLT, or individual PON link).

According to the example embodiment of FIG. 5, the data collection modules (not shown) of a plurality of SIP configuration servers 510a-n are each configured to collect data 571a-n from at least one respective ONT (not shown) in at least one respective network 520. The data collection modules (not shown) of the SIP configuration servers 510a-n of the example embodiment are also configured to report representations 581a-n of the collected data 571a-n to a remote location 590 (e.g., central technical support server), as in the example embodiment of FIG. 4.

According to the example embodiment, communications between the SIP configuration servers 510a-n and their respective ONTs (not shown) are accomplished via ONT Management Control Interfaces (OMCIs) 570a-n, and communications between the SIP configuration servers 510a-n and the remote central location 590 are accomplished via Secure Hyper-Text Transfer Protocol (HTTPS) channels 580a-n.

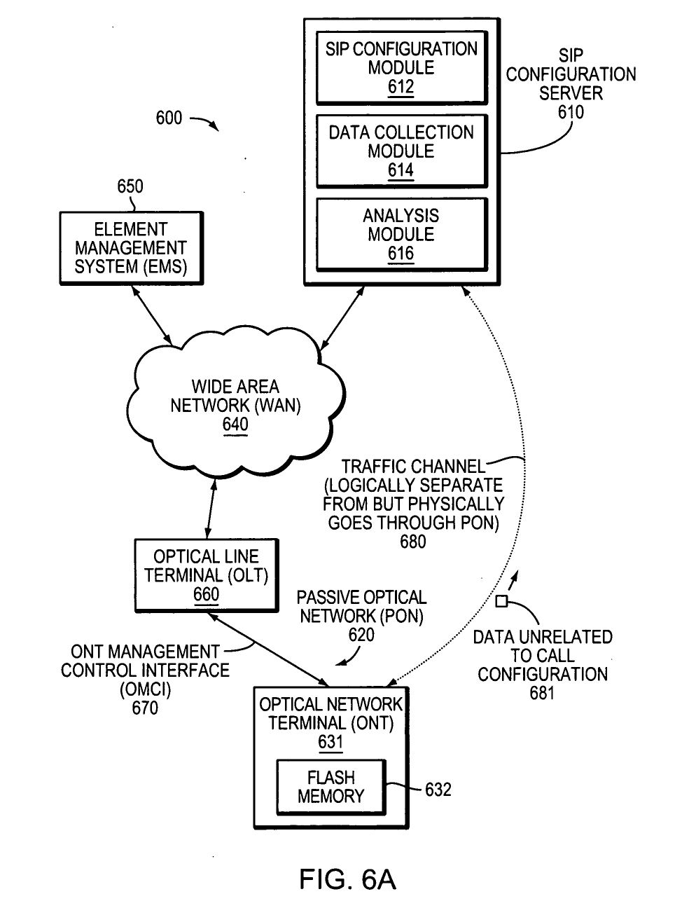

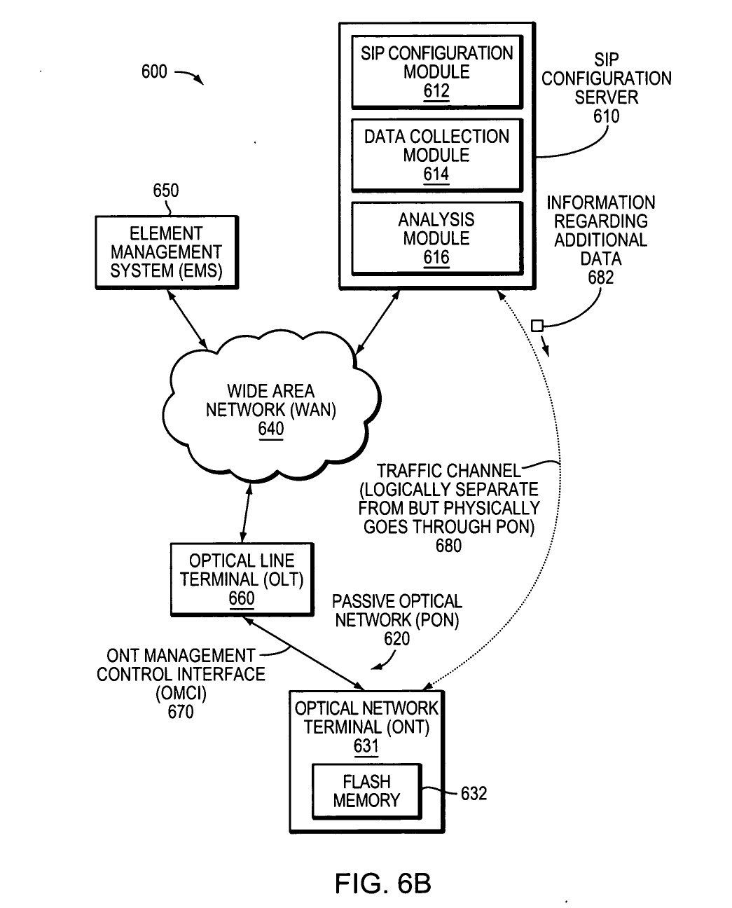

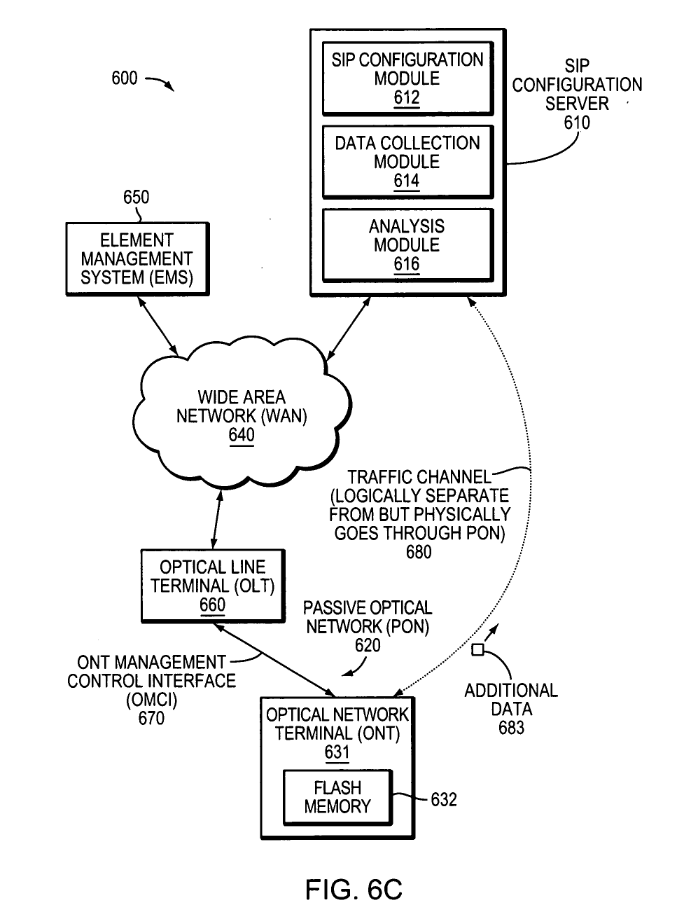

FIG. 6A-6C are network diagrams 600 illustrating collecting data 681 from an ONT 631 and further configuring the ONT 631 based on the collected data 681. Due to the SIP configuration server's 610 unique ability to not require EMS 650 or OLT 660 involvement, an analysis module 616 of the SIP configuration server 610 may adjust and configure the type of data that the ONT 631 supplies to the data collection module 614 of the SIP configuration server 610. FIGS. 6A-6C illustrate an example embodiment that is similar to the embodiment of FIG. 3 and further illustrate a flash memory 632 in the ONT 631 and communications 681-683 between the ONT 631 and the SIP configuration server 610.

FIG. 6A illustrates an embodiment in which the ONT 631 is configured to store data 681 unrelated to its call configuration upon a triggering event and to forward that data 681 to a data collection module 614 of a SIP configuration server 610. Examples of such a triggering event may include an internal triggering event, such as an ONT failure, system crash, or other ONT anomaly, or an external trigger event, such as installation technician trigger mechanism, or other human-to-machine interface, local to the ONT 631. Such an external trigger may be caused by a system as described in U.S. Pat. No. 7,123,692, entitled “Craft Menu System Using Caller ID Functionality for Installation and Testing,” which is incorporated herein by reference in its entirety.

Upon a triggering event, such as, for example, detecting an ONT anomaly, the ONT 631 may write data 681 relating to the event to its memory 632, which may be flash memory for example. Examples of such data 681 may include an application log or a backtrace dump. Once the ONT 631 recovers and ranges, the ONT 631 may then forward the data 681 in the memory 632 to the data collection module 614 of the SIP configuration server 610. As described above, the ONT 631 may send the data 681 to the SIP configuration server 610 via an HTTP channel 680.

FIG. 6B illustrates an embodiment in which an analysis module 616 of the SIP configuration server 610 is configured to analyze the data 681 received from the ONT 631 and to further configure the ONT 631 to return additional data to the data collection module 614 of the SIP configuration server 610. Such a configuration of the ONT 631 may be accomplished by transmitting information 682, such as a configuration script or information, provisioning signal, or diagnostic message to the ONT 631, where the information 682 may specify the type of additional data for the ONT 631 to return to the data collection module 614.

According to the embodiment of FIG. 6B, the analysis module 616 analyzes the data 681 (FIG. 6A) received from the ONT 631 and adjusts the configuration scripts of the ONT 631 based on the received data 681 (FIG. 6A). The embodiment may differentiate the diagnostic/script type based upon whether communication between the ONT 631 and its management node has been established, established and then lost, or never established at all. The analysis module 616 then sends the newly adjusted scripts 682 to the ONT 631 to initiate possible further data retrieval. The ONT 631 may then execute the newly received scripts 682 during the same HTTP transaction.

FIG. 6C illustrates the ONT 631 communicating further data 683 to the data collection module 614 based on the new scripts 682 (FIG. 6B) received from the analysis module 616. It should be noted that the data collection module 614 may store the data 683, 681 (FIG. 6A) received from the ONT 631 at the SIP configuration server 610 and may store different data depending on the type of diagnostics performed. Once the data collection module 614 collects the desired data 683, 681 (FIG. 6A), it may communicate the data 683, 681 (FIG. 6A), or representation thereof, to a central technical support server (not shown) for analysis.

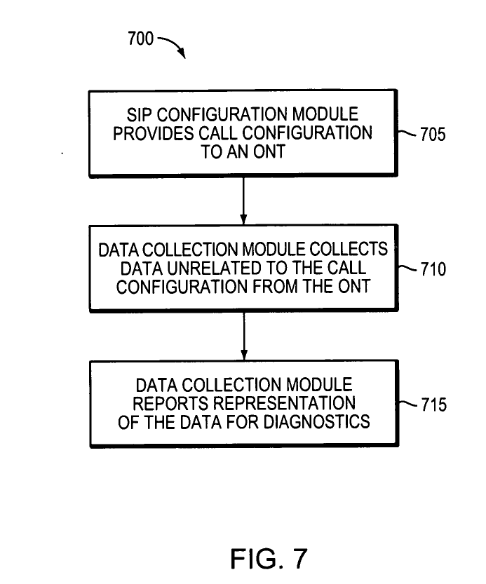

FIG. 7 is a flow diagram 700 illustrating collecting data from an ONT at a SIP configuration server and reporting the data for diagnostics. According to the example method for performing diagnostics on an ONT, a configuration module of a SIP configuration server provides a call configuration to the ONT for use during call operations (705). A data collection module of the SIP configuration server collects data from the ONT that is unrelated to the call configuration (710) and reports a representation of the data for diagnostics (715). In some embodiments, the representation of the data is communicated to a remote technical support server to be analyzed.

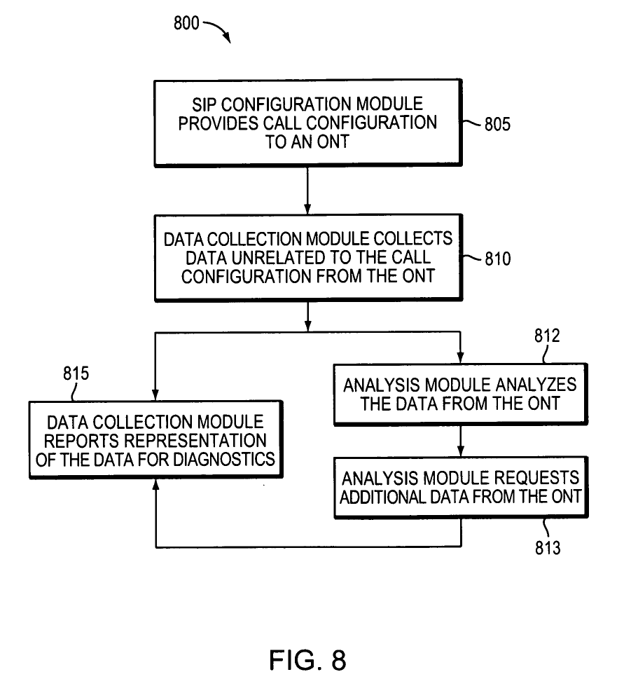

FIG. 8 is a flow diagram 800 illustrating collecting data from an ONT at a SIP configuration server, requesting additional data from the ONT, and reporting the data for diagnostics. As in the example method of FIG. 7, a configuration module provides a call configuration to the ONT for use during call operations (805), and data collection module collects data from the ONT that is unrelated to the call configuration (810). According to the example method of FIG. 8, an analysis module of the SIP configuration server may analyze the data received from the ONT (812) and may then request additional data from the ONT based on the received data (813). The request for additional data may be accomplished using techniques described above (e.g., adjusting ONT scripts). Finally, the method reports a representation of the collected data for diagnostics (815).

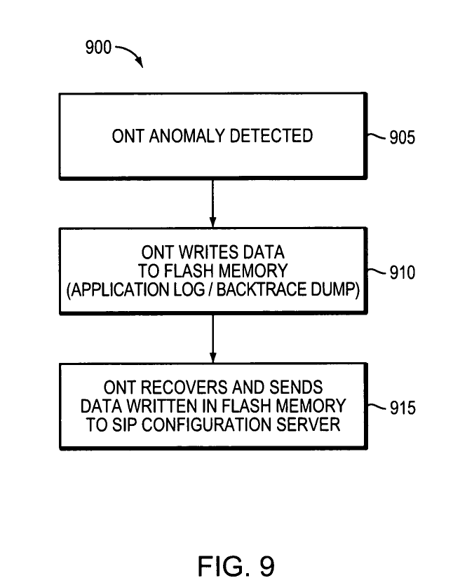

FIG. 9 is a flow diagram 900 illustrating detecting an ONT anomaly or failure, writing data relating to the anomaly or failure to memory, and sending the data to a SIP configuration server. According to the example method of FIG. 9, an ONT may detect an event internal to the ONT, such as an ONT failure, system crash, or other ONT anomaly (905). Upon detection of the event, the ONT writes data relating to the event to memory, such as flash memory (910). As described above, the data written to the memory may include information such as an application log or backtrace dump. Upon recovery of the ONT, the ONT sends the data written to the flash memory to a SIP configuration server for analysis (915).

While this invention has been particularly shown and described with references to example embodiments thereof, it will be understood by those skilled in the art that various changes in form and details may be made therein without departing from the scope of the invention encompassed by the appended claims. For example, embodiments of the present invention may include a feature that provides statistics and graphs relating to that data collected by the SIP configuration server 310 (FIG. 3) as well as a summary of that data.

It should also be understood that the flow diagrams of FIG. 7-9 are examples that may include more or fewer components, be partitioned into subunits, or be implemented in different combinations. Moreover, the flow diagrams may be implemented in hardware, firmware, or software. If implemented in software, the software may be written in any software language suitable for use in systems and networks as illustrated in FIGS. 1-6C. The software may be embodied on any form of computer readable medium, such as RAM, ROM, or magnetic or optical disk, and loaded and executed by generic or custom processor(s).

It should be noted that embodiments of some of the techniques described herein are described as using the Session Initiation Protocol (SIP). A version of the SIP protocol that may adapted for use with the techniques described herein is described in J. Rosenberg et al., “SIP: Session Initiation Protocol,” RFC 3261, June 2002, which is available from the Internet Engineering Task Force (IETF) and which is incorporated herein by reference in its entirety. It should be noted that other protocols and communication techniques may be adapted to be used with the techniques described herein.

What is claimed is:

1. A session initiation protocol (SIP) network node comprising:
a SIP configuration module to provide a call configuration to a terminal node in a SIP network for use during call operations; and
a data collection module configured to collect data from the terminal node unrelated to the call configuration and to report a representation of the data.

2. A SIP network node as in claim 1 wherein the data collection module is configured to report the representation of the data to a remote location for analysis.

3. A SIP network node as in claim 1 further including an analysis module to analyze the data and to cause the terminal node to return additional data to the data collection module, the additional data being unrelated to the call configuration.

4. A SIP network node as in claim 3 wherein the analysis module causes the terminal node to return the additional data by transmitting a configuration script or information, provisioning signal, or diagnostic message to the terminal node.

5. A SIP network node as in claim 3 wherein the analysis module is configured to specify the type of additional data for the terminal node to return to the data collection module.

6. A SIP network node as in claim 1 wherein the data collection module is further configured to cause the terminal node to store data unrelated to the call configuration upon a triggering event and to forward the stored data to the data collection module.

7. A SIP network node as in claim 6 wherein the triggering event is an internal failure of the terminal node.

8. A SIP network node as in claim 6 wherein the triggering event is an event triggered at the terminal node via a human-to-machine interface.

9. A SIP network node as in claim 1 wherein the data collection module is configured to collect different data based on a state of communications between the terminal node and its associated management node.

10. A SIP network node as in claim 9 wherein the data collection module is configured to collect different data based on whether communications between the terminal node and the associated management node have been established, established but later lost, or never established.

11. A method for performing diagnostics on a terminal node in a session initiation protocol (SIP) network, the method comprising:
at a SIP configuration server:
providing a call configuration to the terminal node for use during call operations;
collecting data from the terminal node, the data being unrelated to the call configuration; and
reporting a representation of the data.

12. A method as in claim 11 wherein reporting a representation of the data includes reporting the representation of the data to a remote location for analysis.

13. A method as in claim 12 wherein the SIP network includes a plurality of SIP configuration servers; and
at each SIP configuration server, collecting respective data from at least one respective terminal node, the respective data being unrelated to the call configuration, and reporting a respective representation of the respective data to the remote location.

14. A method as in claim 11 further comprising:
at the SIP configuration server, analyzing the data, and further configuring the terminal node to return additional data to the SIP configuration server, the additional data being unrelated to the call configuration.

15. A method as in claim 14 wherein further configuring the terminal node to return additional data to the SIP configuration server includes transmitting a configuration script or information, provisioning signal, or diagnostic message to the terminal node.

16. A method as in claim 14 wherein further configuring the terminal node to return additional data to the SIP configuration server includes specifying the type of additional data for the terminal node to return to the SIP configuration server.

17. A method as in claim 11 further comprising:
storing at the terminal node data unrelated to the call configuration upon a triggering event; and
forwarding the stored data to the SIP configuration server.

18. A method as in claim 17 wherein storing at the terminal node data unrelated to the call configuration upon a triggering event includes storing at the terminal node data unrelated to the call configuration upon an internal failure of the terminal node.

19. A method as in claim 17 wherein storing at the terminal node data unrelated to the call configuration upon a triggering event includes storing at the terminal node data unrelated to the call configuration upon an event triggered at the terminal node via a human-to-machine interface.

20. A method as in claim 11 wherein collecting data from the terminal node in the SIP network includes collecting different data based on a state of communications between the terminal node and its associated management node.

21. A method as in claim 20 wherein collecting different data based on a state of communications between the terminal node and its associated management node includes collecting different data based on whether communications between the terminal node and the associated management node have been established, established but then lost, or never established.
